(19) United States
(12) Patent Application Publication
(10) Pub. No.: US 2026/0074551 A1
(43) Pub. Date: Mar. 12, 2026

(54) Redundant Power Supply for Electro-Mechanic Brake Systems in a Vehicle

(71) Applicant: KB Intellectual Property GmbH & Co. KG, Pullach (DE)

(72) Inventors: Nora MESZAROS, Gencsapáti (HU); Huba NÉMETH, Budapest (HU); Péter Lindner, Ráckeve (HU); Zoltan Toth, Budapest (HU); Marwa Mohamed, Munich (DE)

(21) Appl. No.: 19/322,865

(22) Filed: Sep. 9, 2025

(30) Foreign Application Priority Data
Sep. 10, 2024 (EP) 24199361.7

(51) Int. Cl. H02J 9/06; B60T 13/74; B60T 17/18

(52) U.S. Cl. CPC H02J 9/061; B60T 13/746; B60T 17/18; B60T 2270/402; B60T 2270/413; B60T 2270/414

(57) ABSTRACT

A redundant power supply system for an electro-mechanical brake system for a vehicle is disclosed having at least two brake circuits, wherein each brake circuit has at least two energy storage device modules connected in series in a configuration so that the two modules together can supply electric power to wheel-end brake actuators.

### CROSS REFERENCE TO RELATED APPLICATION

This application claims priority under 35 U.S.C. § 119 from European Patent Application No. 24 199 361.7, filed Sep. 10, 2024, the entire disclosure of which is herein expressly incorporated by reference.

This application contains subject matter related to U.S. application Ser. No. ______, entitled “Redundant Power Supply System for Electro-Mechanic Brake Systems in a Vehicle,” filed on even date herewith (Attorney Docket No. 125161.PJ186US).

### BACKGROUND AND SUMMARY

With the increasing trend of electrification, Electro-Mechanic Brake Systems (EMBS) come into focus to achieve more precise braking control and faster responses by only using electrical signals and energy medium. Although today in the field of commercial vehicles the pneumatic or hydraulic systems are the most popular solutions, EMBS has several advantages from reduced volume and weight to reduced environmental emission.

These advantages can only be present if the brake system adheres to regulatory standards and certain safety requirements. The power required for the operation of the brake actuators and the control is stored and transmitted from an electric power supply system. Since the malfunction of this supply would result in compromising the braking ability of the vehicle, various levels or numbers of redundancies are required to improve the reliability and availability of the system.

In conventional pneumatic or hydraulic braking systems, the medium of air or hydraulic fluid is used to produce and transmit braking signals and braking force. The electro-mechanical brake on the other hand, represents a technology where both are generated and transmitted by electricity alone. In case of malfunction in the electrical transmission, the driver is not able to rely on any pneumatic or hydraulic backup system.

There is a potential risk of losing braking functionality and a risk of failing to deliver the expected braking performance and stability functions in case of failure in the power supply system without any backup options. The EMBS wheel-end actuators and the control units require stable and sufficient power to function properly. Therefore, a redundant power supply system (rPMS) is needed to be able to fulfil the braking performance requested by the driver or based on an automated driving system's command.

For example, a system and method for providing redundant electric power is known from EP 3626505 A1. It discloses a redundant electric power supply system to at least one vehicle component. It contains at least one power management unit connected to the vehicle power network and one or more storage units where electric energy is stored. A vehicle component is connected to at least two storage units to provide a redundant supply.

Further prior art is known, e.g., from WO 2023001770 A1 or EP 4077079 A1.

It is an object of the invention to provide an improved redundant power supply for electro-mechanic brake systems.

This object is achieved by a system according to the independent claims. Further advantageous developments are subject matters of the dependent claims.

The present invention discloses a solution where the electro-mechanical brake system has at least two separate circuits each supplied by a dedicated power supply unit. Each power supply unit is partitioned to two energy storage device submodules connected in series. A DC/DC converter is responsible for charging the energy storages from the vehicle board network and another DC/DC is used to balance the charge levels between the submodules. Since the role of this latter DC/DC converter is for balancing, it does not have to be Automotive Safety Integrity Level (ASIL) rated. U₁ voltage level is provided for the operation of the brake actuators and U₂ voltage level is provided in each circuit for the ECUs and sensors. In case of malfunction of the upper submodule, a U₂ voltage level can still be provided to ensure the mentioned control electronic function from the lower supply submodule.

In particular, the present invention discloses a solution wherein a redundant power supply system comprises at least two brake circuits wherein each brake circuit comprises at least two energy storage device modules connected in series in a configuration, so that the two modules together can supply electric power to brake actuators.

Preferably, the redundant power supply system (rPMS) comprises safety switches, preferably smart safety switches, for the at least two energy storage device modules being configured such that the energy storage device modules can be decoupled by the safety switches.

The advantage of the smart fuses and switches is the protection. In case of a failure in one of the components (like short circuit etc..) other components or other parts of the circuits can be decoupled and protected. This way partial operation of a circuit can still be ensured and the costs are reduced since not all components have to be replaced if a failure happens.

Additionally, they can measure current and voltage, they are controlled by the ECU, they are faster this way in reaction than the melting fuses, they are better suited for safety relevant applications. The difference between them is not significant. Between two active components (like DC/DC or energy storage) a switch is used and between a load and an energy source a fuse is used.

Preferably, the redundant power supply system (rPMS) comprises smart fuses for wheel-end brake actuators being configured such that the wheel-end brake actuators can be decoupled through the smart fuses.

Advantageously, the redundant power supply system (rPMS) comprises at least a DC/DC converter to provide power required by the energy storage modules for charging.

In general, a system for commercial vehicles is equipped with a redundant power supply system (rPMS) for an electro-mechanical brake system, wherein the redundant power supply system in each brake circuit contains at least two energy storage device modules connected in series, so that the lower part of the modules supplies safety critical loads/consumers.

Preferably, the system comprises smart fuses configured such that the safety critical loads can be decoupled by smart fuses. The advantages are the same as mentioned above.

The safety critical load preferably can be a brake control ECU, a redundant Foot Brake Sensor, a redundant Trailer Control Module, a Hand Control Module, or any sensors.

This allows a wide range of loads, etc. to be supplied.

The system preferably comprises a DC/DC converter that performs balancing between upper and lower energy storage modules connected in series.

Since the energy storage module is providing U2 for the loads, the DC/DC converter is used to balance the charge levels between the energy storage modules.

The system preferably comprises smart safety switches configured such that the DC/DC converter can be decoupled by the smart safety switches. The advantages are the same as mentioned above.

The system is preferably configured such that in case of failure of the upper energy storage module, the lower one can still ensure the power output for the safety critical loads.

The system can tolerate the fault of the upper module and still provide U2 (U1 is, of course, lost but U2 could be enough to perform some tasks).

The redundant power supply system preferably comprises a normally closed switch to ensure power for the Foot Brake Sensor in an (ignition) OFF state.

This measure enhances the safety of the brake system even if the vehicle is in an OFF state at a standstill position.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic view of a redundant commercial vehicle electro-mechanic brake system.

FIG. 2 is a schematic view of a circuit of the brake system with the power management in focus.

FIG. 3 shows two circuits 1 and 2 of the brake system with the focus of the rPMS modules and their contents.

FIG. 4 shows one circuit with a normally closed switch for supplying the rFBS in case of a vehicle in an OFF state.

### DETAILED DESCRIPTION OF THE DRAWINGS

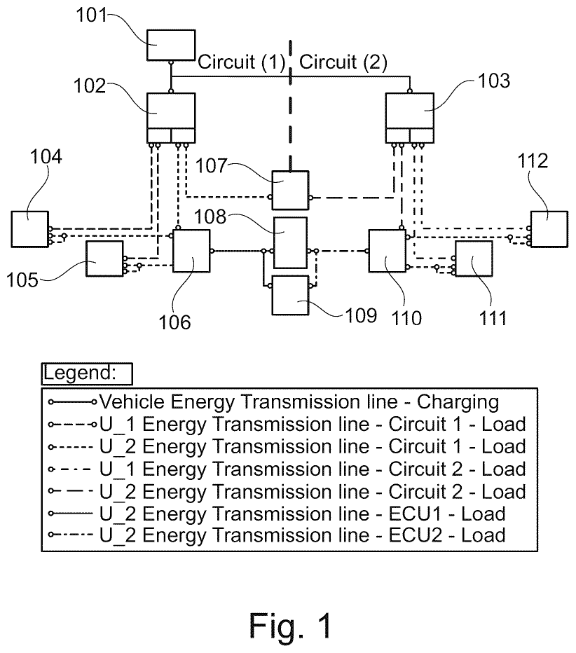

In FIG. 1, a brake system architecture of a commercial vehicle with redundant power supply is shown. The electro-mechanic brake system is composed of the following main components.

There are at least two main brake circuits (1) and (2) that are independent from each other. The brake system is redundantly supplied by redundant Power Management Systems (rPMS) 102 and 103. Both rPMS energy storages are connected to and charged from a vehicle board network 101. The redundant power management system rPMS 102 dedicatedly supplies in the example the front axle, and the redundant power management system rPMS 103 supplies the rear axle of the vehicle.

A Hand Control Unit (HCU) 107, a redundant Foot Brake Sensor (rFBS) 108 and a redundant Trailer Control Modul (rTCM) 109, if available, are supplied redundantly from each of the power supply circuits.

Front axle wheel-end actuators 104 and 105 receive the required voltage level U₁ for the brake actuation from rPMS 102. A first brake circuit's Electronic Control Unit (ECU) 106 and sensors within wheel-end actuators 104 and 105 receive the required voltage level U₂ for their operation from rPMS 102.

In a similar way, rear axle wheel-end actuators 111 and 112 receive the required voltage level U₁ for the brake actuation from rPMS 103. A second circuit's ECU 110 and sensors within the wheel-end actuators 111 and 112 receive the required voltage level U₂ for their operation from rPMS 103.

Recuperation from the brake actuators is possible and handled by the corresponding rPMS modules.

Within each of the power supply circuits there are smart safety switches (SSSW) to decouple circuits from the board network and from each other. Furthermore, there are multiple smart fuses (SF) that protect the different loads/consumers in case of a malfunction of other consumers.

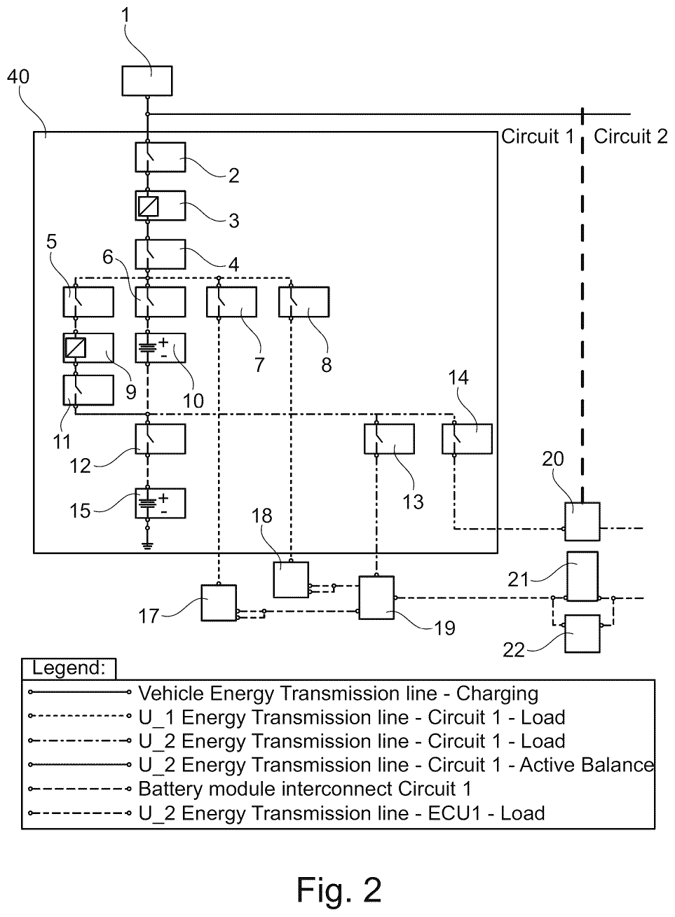

FIG. 2 shows the rPMS unit in circuit (1). In circuit (1), smart safety switches SSSW 2 and 4 can decouple the Direct-Current-to-Direct-Current converter (DC/DC) 3 to fulfil the safety requirements of circuit separation in case of failure of the DC/DC 3 converter itself. Similarly, smart safety switches SSSW 5 and 11 can decouple a charge balancing DC/DC converter 9. A further smart safety switch SSSW 12 can separate two energy storage modules 10 and 15, and a smart safety switch SSSW 6 can decouple the energy storage modules 10 and 15 from the board network path.

A smart fuse SF 7 protects a wheel-end brake actuator 17, smart fuse SF 8 protects a wheel-end brake actuator 18, while a smart fuse SF 13 protects an ECU 19, and a smart fuse SF 14 protects a hand control unit HCU 20.

The power input path of this circuit is connected to the vehicle's board network 1 through the DC/DC converter 3. The DC/DC converter 3 operates to provide power conversion to meet the requirements of the energy storage devices.

The two U₂ voltage level energy storage modules 15 and 10 connected in series, where the energy storage module 10 is an upper energy storage module and the energy storage module 15 is a lower energy storage module, are able to provide U₁ voltage level together required for the wheel-end brake actuators 17, 18. Additionally, the DC/DC converter 9 performs active charge balancing between the upper 10 and the lower energy storage modules 15 ensuring coherent operation of storage devices connected in series and balancing their charge levels, since the lower module 15 is responsible for providing U₂ for the ECU 19 and other loads. Since the DC/DC converter 9 does not directly supply currents to consumers and the overall system relies on ASIL rated power output from the energy storage modules 10 and 15, it is sufficient to have a quality managed (QM) DC/DC converter 9 component.

The energy storage module (e.g. battery) configuration proposed by this architecture ensures that in case of failure of the upper energy storage module 10, the lower module 15 can still provide the U2 for the loads like ECU 19, and HCU 20, this way through ECU 19 the following loads can also be supplied e.g. a foot brake sensor 21 and a redundant Trailer control module 22.

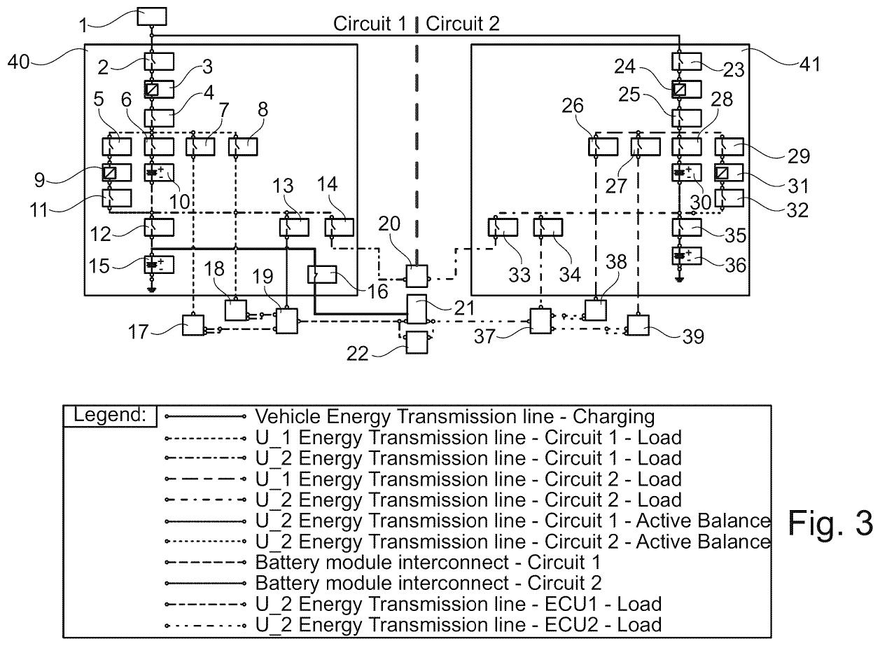

The setup of circuit (2) is done in a similar way as discussed, see in FIG. 3.

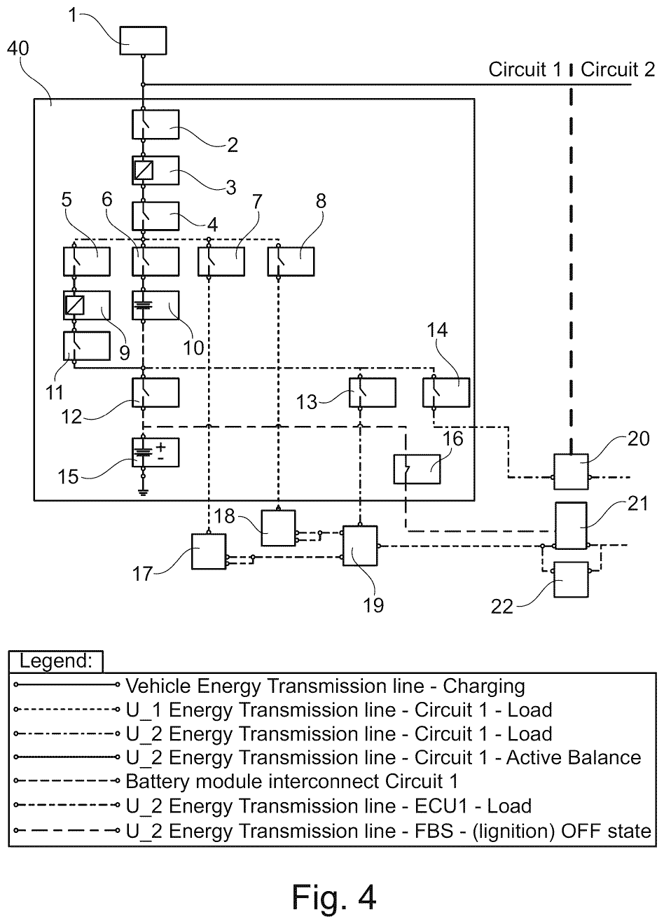

The layout in FIG. 4 represents a rPMS system with an additional normally closed smart fuse SF-NC 16. The SF-NC 16 is used to provide power to the redundant foot brake sensor 21 when the vehicle is in an (ignition) OFF state, and the braking system is deactivated, so that a brake pedal movement can trigger a braking event even in the OFF state. When the vehicle is in (ignition) ON state, and the rPMS is in operational state, then the SF-NC 16 is in open state and redundant foot brake sensor 21 can be supplied by the electronic control unit of brake control 19 directly.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE SIGNS

1 Board network
2 smart safety switch SSSW
3 DC/DC converter (for charging)
4 smart safety switch SSSW
5 smart safety switch SSSW
6 smart safety switch SSSW
7 smart fuse SF
8 smart fuse SF
9 DC/DC converter (for balancing)
10 (upper) energy storage module
11 smart safety switch SSSW
12 smart safety switch SSSW
13 smart fuse SF
14 smart fuse SF
15 (lower) energy storage module
16 smart fuse SF-NC
17 wheel-end brake actuator
18 wheel-end brake actuator
19 ECU 1 brake control
20 hand control unit HCU
21 foot brake sensor
22 redundant trailer module
23 smart safety switch SSSW
24 DC/DC converter (for charging)
25 smart safety switch SSSW
26 smart fuse
27 smart fuse
28 smart safety switch SSSW
29 smart safety switch SSSW
30 (upper) energy storage module
31 DC/DC converter (for balancing)
32 smart safety switch SSSW
33 smart fuse SF
34 smart fuse SF
35 smart safety switch SSSW
36 (lower) energy storage module
37 ECU 1 brake control
38 wheel-end brake actuator
39 wheel-end brake actuator
40 redundant power management system rPMS (circuit 1)
41 redundant power management system rPMS (circuit 2)
101 board network
102 redundant power management system rPMS (circuit 1)
103 redundant power management system rPMS (circuit 2)
104 wheel-end brake actuator
105 wheel-end brake actuator
106 electronic control unit ECU (circuit 1)
107 hand control unit HCU
108 redundant foot brake sensor rFBS
109 redundant trailer control module rTCM
110 second circuit's ECU
111 wheel-end brake actuator
112 wheel-end brake actuator

What is claimed is:

1. A redundant power supply system for an electro-mechanical brake system for a vehicle, the redundant power supply system comprising:
at least two brake circuits,
wherein each brake circuit comprises at least two energy storage device modules connected in series in a configuration so that the two modules together are able to supply electric power to brake actuators.

2. The redundant power supply system according to claim 1, further comprising:
safety switches for said at least two energy storage device modules, the safety switches being configured such that the energy storage device modules are decouplable by said safety switches.

3. The redundant power supply system according to claim 1, further comprising:
smart fuses for wheel-end brake actuators, the smart fuses being configured such that said wheel-end brake actuators are decouplable through said smart fuses.

4. The redundant power supply system according to claim 1, further comprising:
at least a DC/DC converter to provide power required by the energy storage device modules for charging.

5. The redundant power supply system according to claim 1, wherein
the redundant power supply system in each brake circuit contains at least two energy storage modules connected in series, configured such that a lower part of the modules supplies safety critical loads/consumers.

6. The redundant power supply system according to claim 5, further comprising:
smart fuses configured such that the safety critical loads are decouplable by said smart fuses.

7. The redundant power supply system according to claim 6, wherein
the safety critical load is a brake control ECU, a redundant Foot Brake Sensor, a redundant Trailer Control Module, a Hand Control Module, or any sensors.

8. The redundant power supply system according to claim 1, further comprising:
a DC/DC converter configured so as to perform balancing between the energy storage device modules wherein an upper and a lower energy storage module are connected in series.

9. The redundant power supply system according to claim 8, further comprising:
smart safety switches configured such that the DC/DC converter is decouplable by said smart safety switches.

10. The redundant power supply system according to claim 6, wherein the system is configured such that, in case of a failure of an upper energy storage module, the lower energy storage module can still ensure power output for the safety critical loads.

11. The redundant power supply system according to claim 1, further comprising:
a normally closed switch to ensure power for a Foot Brake Sensor in an ignition OFF state.

12. A commercial vehicle comprising a redundant power supply system according to claim 1.
